(19) United States
(12) Patent Application Publication
(10) Pub. No.: US 2019/0357055 A1
(43) Pub. Date: Nov. 21, 2019

(54) ACCESS POINT AND OPERATING METHOD OF ACCESS POINT

(71) Applicant: ACCTON TECHNOLOGY CORPORATION, HSINCHU (TW)

(72) Inventor: Chien-Hong LIU, Changhua County (TW)

(21) Appl. No.: 16/147,851

(22) Filed: Sep. 30, 2018

(30) Foreign Application Priority Data
May 15, 2018 (TW) 107116478

(51) Int. Cl. H04W 16/18

(52) U.S. Cl. CPC H04W 16/18; H04W 88/08

(57) ABSTRACT

An operating method of a wireless access point includes determining the wireless access point is in a first state or a second state; under a condition that the wireless access point is in the first state, receiving a first linking request packet from a first access point, and selectively building a first wireless distribution system (wireless distribution system) connection with the first access point according to the first linking request packet; and under a condition that the wireless access point is in the second state, providing a second linking request packet to a second access point, so as to allow the second access point to build a second wireless distribution system connection with the second access point according to the second linking request packet.

### RELATED APPLICATIONS

This application claims priority to Taiwan Application Serial Number 107116478, filed May 15, 2018, which is herein incorporated by reference.

### BACKGROUND

### Technical Field

The present disclosure relates to a network device and an operating method thereof. More particularly, the present disclosure relates to a wireless access point, and the operating method thereof.

### Description of Related Art

With the development of electronic technology, wireless access point has been widely used in people's living.

In some applications, wireless access point may use wireless distribution system (WDS) to connect with another wireless access point to expand the coverage of wireless network. However, in every expansion performed, user must set the wireless access point, which causes inconvenience to the user. Therefore, an improvement method is proposed.

### SUMMARY

An aspect of the present disclosure is a wireless access point. According to an embodiment of the present disclosure, the wireless access point includes a communication component and one or more processing components. The processing components are configured to determine the wireless access point works in the first state or second state. Under a condition that the wireless access point works in the first state, the wireless access point receives a first linking request packet from a first wireless access point via the communication component, and selectively controls the communication component to build a first wireless distribution system with the first wireless access point according to the first linking request packet. If the wireless access point works in the second state, the wireless access point controls the communication component to provide a second linking request packet to a second wireless access point, and the second wireless access point selectively builds a second wireless distribution system with the wireless access point selectively according to the second linking request packet.

Another aspect of the present disclosure is an operating method of wireless access point. According to an embodiment of present disclosure, the operating method including determines the wireless access point is in the first state or second state; under a condition that the wireless access point is in the first state, the wireless access point receives a first linking request packet from a first wireless access point via the communication component, and the wireless access point selectively builds a first wireless distribution system with the first wireless access point according to the first linking request packet; under a condition that the wireless access point is in the second state, the wireless access point provides a second linking request packet to a second wireless access point, such that the second wireless access point selectively builds a second wireless distribution system connection with the wireless access point according to the second linking request packet.

### BRIEF DESCRIPTION OF THE DRAWINGS

FIG. 1A is a diagram of a wireless access point according to an embodiment of the present disclosure.

FIGS. 1B, 1C are operation diagrams of the wireless access point according to an embodiment of the present disclosure.

FIGS. 2A, 2B are operation diagrams of the wireless access point according to an embodiment of the present disclosure.

FIG. 3 is an operation diagram of the wireless access point according to an embodiment of the present disclosure.

FIG. 4 is a flowchart of an operating method of the wireless access point according to an embodiment of the present disclosure.

### DETAILED DESCRIPTION

Reference will now be made in detail to the present embodiments of the disclosure, examples of which are illustrated in the accompanying drawings. It will be apparent to those skilled in the art that after understanding the embodiments of the present disclosure, various modifications and variations can be made based on the teaching of the disclosure without departing from the scope or spirit of the disclosure.

It will be understood that, in the description herein and throughout the claims that follow, the term “electrically connect” may indicate that two or more components being directly physically contacted or electrically contacted with each other, or indirectly physically contacted or electrically contacted with each other. That is, intervening elements may be present. Moreover, “electrically connect” or “connect” may further refer to the interoperation or interaction between two or more elements.

It will be understood that, in the description herein and throughout the claims that follow, although the terms “first,” “second,” etc. may be used to describe various elements, these elements should not be limited by these terms. These terms are only used to distinguish one element from another. For example, a first element could be termed a second element, and, similarly, a second element could be termed a first element, without departing from the scope of the embodiments.

It will be understood that, in the description herein and throughout the claims that follow, the terms “comprise” or “comprising,” “include” or “including,” “have” or “having,” “contain” or “containing” and the like used herein are to be understood to be open-ended, i.e., to mean including but not limited to.

It will be understood that, in the description herein and throughout the claims that follow, the phrase “and/or” includes any and all combinations of one or more of the associated listed items.

The terms used in this specification and claims, unless otherwise stated, generally have their ordinary meanings in the art, within the context of the disclosure, and in the specific context where each term is used. Certain terms that are used to describe the disclosure are discussed below, or elsewhere in the specification, to provide additional guidance to the practitioner skilled in the art regarding the description of the disclosure.

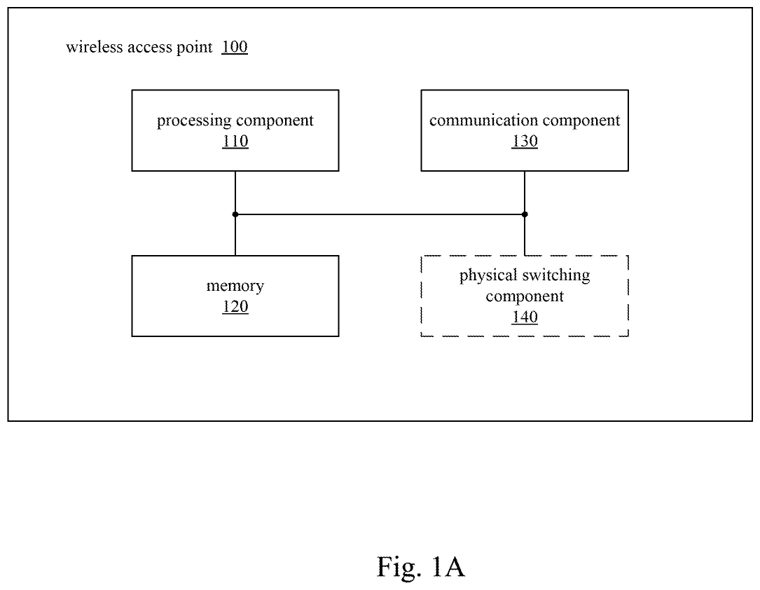

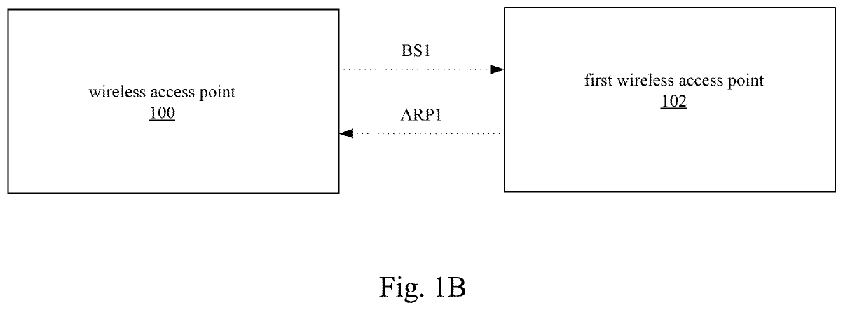

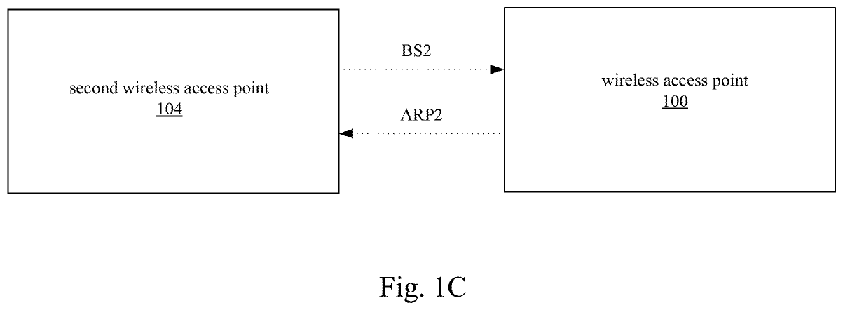

FIG. 1A is a wireless access point diagram according to an embodiment of the present disclosure. In the present embodiment, the wireless access point 100 includes a processing component 110, a memory 120 and a communication component 130. In some embodiments, the wireless access point 100 further includes a physical switching component 140. In the present embodiment, the processing component 110 is electrical connected to the memory 120 and the communication component 130.

In an embodiment, the aforementioned processing component 110 may be implemented by, for example, a central processor and/or a microprocessor, but are not limited thereto. In an embodiment, the memory 120 may include one or more memory devices, each of which includes, or a plurality of which collectively include the computer readable storage medium. The memory 120 may include a read-only memory (ROM), a flash memory, a soft disk, a hard disk, a disk, a flash disk/drive, a magnetic tape, a database accessible from a network, or any storage medium with the same function that can be easily thought by those skilled in the art. In an embodiment, the communication component 130 may be implemented by a wireless communication chip, and/or other components with communication capabilities, but is not limited thereto.

In an embodiment, the aforementioned processing component 110 may run or execute various software programs and/or instruction sets stored in the memory 120, in order to execute various functions and perform data processing of the wireless access point 100.

It should be noted that, the implementation of the devices and components in the above wireless access point 100 are not limited by those disclosed in the above embodiments, and the connection among these devices and components are not limited to the above embodiments. Any configuration and interconnections that would enable the wireless access point 100 to practice the following technical features may be used in the present disclosure.

In an embodiment, one or more processing components 110 may determine whether the wireless access point 100 is in a first state or a second state. In an embodiment, for example, the first state may be a wireless distribution system master (WDS mater) state, the second state may be a wireless distribution system slave (WDS slave) state.

Referring to FIG. 1B, in an embodiment, under a condition that the wireless access point 100 is in the first state (wireless distribution system master state), the processing component 110 may receive a first linking request packet ARP1 from the first wireless access point 102 via the communication component 130, and the wireless access point 100 selectively controls the communication component 130 to build the wireless distribution system connection with the first wireless access point 102 according to the first linking request packet ARP1.

In an embodiment, under a condition that the wireless access point 100 is in the first state (e.g., wireless distribution system master state), before receiving the linking request packet ARP1, the wireless access point 100 may broadcast the beacon signal BS1. In some embodiments, this operation may be omitted.

Referring to FIG. 1C, in an embodiment, under a condition that the wireless access point 100 is in the second state (e.g., wireless distribution system slave state), the processing component 110 may control the communication component 130 to provide the second linking request packet ARP2 to the second wireless access point 104, such that the second wireless access point 104 selectively builds the wireless distribution system connection with the wireless access point 100 according to the second linking request packet ARP2 from the wireless access point 100.

In an embodiment, before providing the linking request packet ARP2, the wireless access point 100 may receive the beacon signal BS2 from the aforementioned second wireless access point 104, and provide the linking request packet ARP2 to the second wireless access point 104 according to the beacon signal BS2. In some embodiments, the operation of receiving the beacon signal BS2 may be omitted.

In an embodiment, the aforementioned first and second wireless access points 102, 104 may have the same structure and function as the wireless access point 100, therefore, the features of the wireless access point 100 and the first and second wireless access points 102 and 104 described in this document may be used in common with each other. In an embodiment, the first wireless access point 102 is in the aforementioned second state, and the second wireless access point 104 is in the aforementioned first state.

In an embodiment, the connection information (such as encryption, service set identifier (SSID), and/or channel) for the wireless distribution system of the wireless access point 100, the first and the second wireless access points 102, 104 are preset in the wireless access point 100, the first and the second wireless access points 102, 104. So the wireless access point 100 may automatically build the wireless distribution system connection with the first and the second wireless access point 102, 104.

Alternatively stated, in an embodiment, the wireless access points in different states may be used to automatically build the wireless distribution system connection between them.

In an embodiment, the wireless access point 100 supports the interface of virtual access point (VAP) to build the wireless distribution system network connection with other virtual wireless access points via the network interface of virtual access point instead of the network interface of the wireless distribution system of the physical wireless access point. For example, wireless access point 100 is the virtual wireless access point typically set up on wireless access point. In this example, the default interface for building the connection of the wireless distribution system at the wireless access point 100 is a virtual access point network interface.

Referring to FIG. 1B, the wireless access point 100 and the first wireless access point 102 are both using the interface of the virtual access point to implement the wireless distribution system connection. In this example, the explanation is made by taking the wireless access point 100 in the first state, and the first wireless access point 102 in the second state. The present disclosure may also substitute the first state and the second state of the wireless access point 100 and the first wireless access point 102 in the wireless distribution network.

When the wireless access point 100 is set in the first state, the wireless access point 100 will receive packet via network interface of virtual access point. In this case, when wireless access point 100 receives the packets, the wireless access point 100 works like a general wireless access point and does not specifically determine the source of the packet. For example, the wireless access point 100 will analysis all the received packets, obtaining the source media access control address and send the beacon signal BS1.

On the other hand, when the first wireless access point 102 is set in the second state, the first wireless access point 102 will scan whether there is the beacon signal BS1 in its wireless signal coverage via the network interface of a virtual wireless access point supported by itself. If the first wireless access point 102 scans and receives the beacon signal BS1, the first wireless access point 102 will analyze the signal source of the beacon signal BS1. If the source of this beacon signal BS1 is the wireless access point 100 (that is, the wireless access point in the wireless distribution system master state), then, the first wireless access point 102 sends the linking request packet ARP1 to the wireless access point 100. In an example, the linking request packet ARP1 may be the association request packet or other similar packets that aim at building connection.

After receiving the linking request packet ARP1, the wireless access point 100 will analyze the content of the linking request packet ARP1 to determine whether to build a connection. For example, the wireless access point 100 reads the organization unique identifier in the linking request packet ARP1 to determine whether the organization unique identifier is consistent with the unique identifier of the organization stored in the memory 120 of the wireless access point 100. If so, the wireless access point 100 marks the media access control address of the first wireless access point 102 as the wireless distribution system subordinate client on the wireless distribution system client list stored in the memory 120. Then the wireless access point 100 returns a synchronization signal to the first wireless access point 102 for the first wireless access point 102 to obtain the synchronization information. According to the synchronization information, the first wireless access point 102 joins the network architecture of the wireless distribution system of the wireless access point 100 by the wireless distribution system subordinate state. Therefore, the wireless access point 100 in the network topology of the wireless distribution system successfully joins the first wireless access point 102 of the wireless distribution system subordinate state.

In another embodiment of the present disclosure, wireless access point 100 supports the wireless distribution system network interface for wireless distribution system connection. For example, the wireless access point 100 is the physical wireless access point which disposes the wireless distribution system network interface as a wireless distribution system wireless access point. On the other hand, the present disclosure does not limit whether the virtual wireless access point is set in the wireless distribution system wireless access point, for example, the wireless distribution system wireless access point also supports the function of the virtual wireless access point.

Referring to FIG. 1C, the wireless access point 100 and the second wireless access point 104 perform the wireless distribution system connection by the network interface of the wireless distribution system. In this example, the explanation is made by taking the second wireless access point 104 in the first state and the wireless access point 100 in the second state, the present disclosure may also substitute the first state and the second state of the second wireless access point 104 and the wireless access point 100 in the wireless distribution network.

In an embodiment, under a condition that the second wireless access point 104 is set in the first state by a hardware switch or a physical switching component 140, the second wireless access point 104 receives packet via the network interface of wireless distribution system. In this case, when the second wireless access point 104 receives packet, the wireless access point 104 does not specifically determine the source of the packet and will send the beacon signal BS2 like a general wireless access point.

On the other hand, under a condition that the wireless access point 100 is set in the second state by a hardware switch or a physical switching component 140. In this example, the wireless access point 100 is used for building the default interface of wireless distribution system network connection as the wireless distribution system network interface, moreover, the wireless access point 100 further has virtual access point to perform other network functions.

The wireless access point 100 scans whether there is the beacon signal BS2 in its wireless signal coverage via the wireless distribution system network interface. After scanning the beacon signal BS2, the wireless access point 100 will analysis the signal source of the beacon signal BS2. When the wireless access point 100 verifies the source of the beacon signal BS2 as the second wireless access point 104 (that is, the wireless access point in the wireless distribution system master state), then the wireless access point 100 sends the linking request packet ARP2 to the second wireless access point 104. In an example, the linking request packet ARP2 may be the association request packet or other similar packets that aim at building connection.

At the same time, after receiving the linking request packet ARP2, the second wireless access point 104 will determine whether there are network services to other wireless access point by the interface of the virtual access point. If so, the second wireless access point 104 will temporarily shut down the virtual access point network interface to stop the virtual access point service until the second wireless access point 104 builds the wireless distribution system with the wireless access point 100.

After receiving the linking request packet ARP2 via wireless distribution system network interface, the second wireless access point 104 will analyze the content of the linking request packet ARP2 to determine whether to build a connection. The method of determination is similar to the foregoing, and it will not be repeated here.

In another embodiment, when the wireless access point 100 in the process of building the wireless distribution system network connection and subsequent data transmission in wireless distribution system, it only supports wireless distribution system network interface instead of the network function of virtual access point. When the wireless access point 100 builds the wireless distribution system connection with the second wireless access point 104 or performs wireless distribution system data exchange, the present disclosure does not limit the virtual access point operation of the wireless access point 100 with the second wireless access point 104.

In an embodiment, under a condition that the wireless access point 100 is in the first state (refer to FIG. 1B), the processing component 110 further may verify the verification information of the first linking request packet APR1 from the first wireless access point 102. Under a condition that the verification passed, the processing component 110 may control the communication component 130 to build the wireless distribution system connection with the first wireless access point 102. Under a condition that the verification failed, the processing component 110 prohibits the communication component 130 from building the first wireless distribution system connection with the first wireless access point 102, and discard the first linking request packet ARP1.

In an embodiment, the aforementioned verification information may be the organizationally unique identifier of the first wireless access point 102 and/or product name, but are not limited thereto. In this embodiment, the processing component 110 may determine whether the organizationally unique identifier of the first wireless access point 102 and/or product name are correct (for example, whether it is in the wireless distribution system connection allow list (for example, stored in the memory 120 of the wireless access point 100)) to determine whether the verification is passed. If yes, the verification passes. If not, the verification fails.

For example, in an embodiment, when the organization unique identifier of the first wireless access point 102 is the same as the organization unique identifier of the wireless access point 100, the verification passes. When the organization unique identifier of the first wireless access point 102 is different from the organization unique identifier of the wireless access point 100, the verification fails.

By such operation, the security of the wireless distribution system connection is ensured.

It should be noted that, in an embodiment, under a condition that the wireless access point 100 is in the second state (refer to FIG. 1C), the second linking request packet ARP2 provided by the wireless access point 100 to the second wireless access point 104 may also include the verification information. So that the second wireless access point 104 bases on it to decides whether to build a wireless distribution system connection with the wireless access point 100. In an embodiment, for example, the verification information may be the organization unique identifier and/or product name of the wireless access point 100, but are not limited thereto.

In an embodiment, under a condition that the wireless access point 100 is in the first state (refer to FIG. 1B), if the verification passed, the processing component 110 may add the source MAC address of the first linking request packet ARP1 to the wireless distribution system client table. Then, the first wireless access point 102 may synchronize its settings with the wireless access point 100 to perform an association operation of the wireless distribution system.

In an embodiment, under a condition that the wireless access point 100 in the second state (refer to FIG. 1C), after the wireless access point 100 builds the wireless distribution system connection with the second wireless access point 104, if the wireless distribution system connection is disconnected, the processing component 110 may control the communication component 130 to continuously provide the second linking request packet ARP2 to the second wireless access point 104 until the wireless distribution system connection is rebuilt. In an embodiment, the processing component 110 may suspend its wireless network service until the wireless distribution system is rebuilt.

In an embodiment, the wireless access point 100 may further include the physical switching component 140. In an embodiment, the physical switching component 140 electrically connects with the processing component 110. In an embodiment, the physical switching component 140 may switch the wireless access point 100 to the first switching state and the second switching state, so that the processing component 110 may determine the wireless access point 100 is in the first or second state according to the switching state of the physical switching component 140. It should be noted that, in the different embodiments, the processing component 110 may determine the wireless access point 100 is in the first or second state according to other conditions (such as control commands or user settings), the present disclosure is not limited thereto.

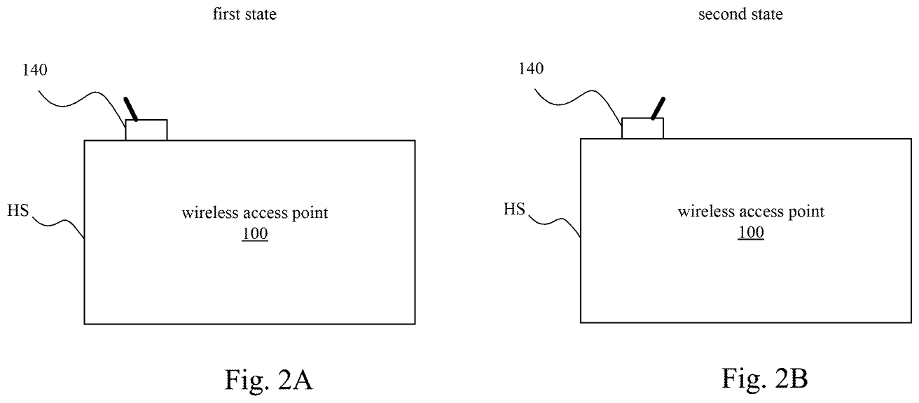

Referring to FIGS. 2A and 2B, in an embodiment, when the physical switching component 140 is switched to the first switching state, the processing component 110 may determine the wireless access point 100 is in the first state according to the first switching state of the physical switching component 140. When the physical switching component 140 is switched to the second switching state, the processing component 110 may determine the wireless access point 100 is in the second state according to the second switching state of the physical switching component 140.

In an embodiment, the physical switching component 140 may set in the housing HS of the wireless access point 100. In an embodiment, the physical switching component 140 may change the switching state according to the user's operation. For example, the physical switching component 140 may be a lever or a toggle switch, but the present disclosure is not limited thereto, when the physical switching component 140 is in the second switching state (e.g., the lever is toward the right), the user pulls the lever toward the first direction (e.g., toward the left), the physical switching component 140 will be switched to the first switching state. When the physical switching component 140 is in the first switching state (e.g., the lever is toward the left), the user pulls the lever toward the second direction (e.g., toward the right), the physical switching component 140 will be switched to the second switching state.

By this setting, user may simply switch the first state and the second state of the wireless access point 100, such that the wireless access points in different states may be used to automatically build the wireless distribution system connection between them.

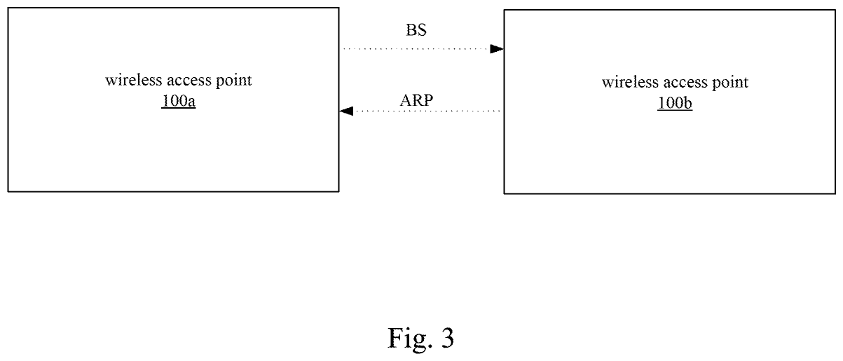

For example, referring to FIG. 3, user may set the physical switching component of the wireless access point 100a (the structure and function are the same as the wireless access point 100) to the first switching state, and set the physical switching component of the wireless access point 100b (the structure and function are the same as the wireless access point 100) to the second switching state, so that the wireless distribution system connection between the wireless access point 100a and 100b is automatically built.

For better understanding, an operation example of present disclosure is provided with FIG. 3 in the following paragraphs, but the present disclosure is not limited thereto.

In this operation example, the structure and function of the wireless access point 100a, 100b are the same as the wireless access point 100. In this operation example, the wireless access point 100a is in the first state, and the wireless access point 100b is in the second state.

In this operation example, the wireless access point 100a may broadcast the beacon signal BS (e.g. the beacon signal). In an embodiment, the beacon signal BS may include the service set identifier (SSID) of the wireless access point 100a.

In this operation example, after receiving the beacon signal BS from the wireless access point 100a, the wireless access point 100b may provide the linking request packet to the wireless access point 100a according to the SSID of wireless access point 100a. In an embodiment, the linking request packet may include the organization unique identifier of the wireless access point 100b.

It should be noted that, in some embodiments, the wireless access point 100a does not provide the beacon signal BS. In such embodiment, the wireless access point 100b prestores the service set identifier of the wireless access point 100a, so that the wireless access point 100b provides the linking request packet to the wireless access point 100a according to that.

In the present operation example, after receiving the linking request packet from the wireless access point 100b, the wireless access point 100a may verify the organization unique identifier of the wireless access point 100b. If verification passed, the wireless access point 100a will build the wireless distribution system connection with the wireless access point 100b. If verification failed, the wireless access point 100a does not build the wireless distribution system connection with the wireless access point 100b.

By the above operation, wireless access points in different states may automatically build wireless distribution system connection between them and other related operations.

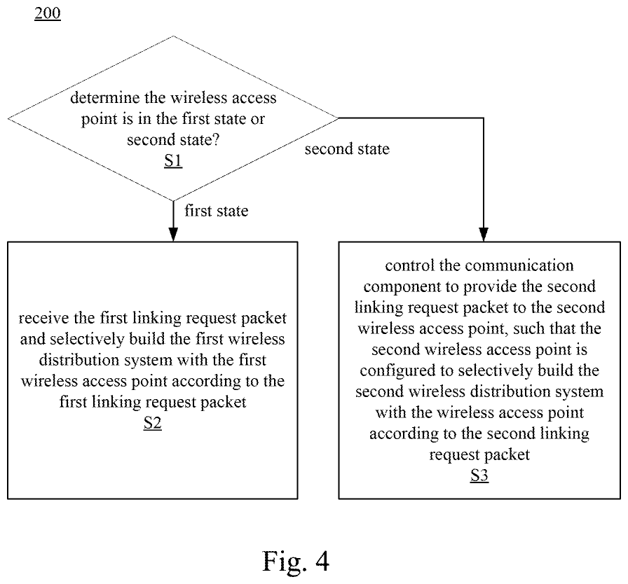

The following will match the operation method shown in FIG. 4 to provide more specific details of present disclosure. However the present disclosure is not limited thereto.

It should be noted that, this operation method may be applied to the same or similar operation method of structure shown in FIG. 1A. To make the description simple, the following according to an embodiment of the present disclosure, taking the wireless access point 100 shown in FIG. 1A as an example to describe the operation method, however the present disclosure is not limited thereto.

In addition, the operating method may be implemented as a computer program, and stored in a non-transitory computer readable recording medium storing program to let the computer, the electronic device, or the aforementioned processing element 110 reads this recording medium and executes the operation method. Non-transitory computer readable recording medium storing program may be a read-only memory, a flash memory, a soft disk, a hard disk, a disk, a flash disk/drive, a magnetic tape, a database accessible from a network, or any storage medium with the same function that can be easily thought by those skilled in the art.

On the other hand, it should be noted that, the operation of the operation method mentioned in the present disclosure, the sequence may be adjusted according to actual needs unless otherwise specified. Moreover, the operation may even be performed simultaneously or partially simultaneously.

Furthermore, in the different embodiments, such operations may also be adaptively added, replaced, and/or omitted as appropriate.

Referring to FIGS. 1A and 4, the operation method 200 includes the following operations.

In the operation S1, the wireless access point is switched to the first switching state or the second switching state by a physical switching element 140, the aforementioned processing component 110 determines the wireless access point 100 is in the first state or second state.

In the operation S2, under a condition that the wireless access point 100 is in the first state, the aforementioned processing component 110 receives the first linking request packet from the first wireless access point 102 via the communication component 130, and the processing component 110 selectively controls the communication component 130 to build the first wireless distribution system connection with the first wireless access point 102 according to the first linking request packet ARP1.

In the operation S3, under a condition that the wireless access point 100 is in the second state, the aforementioned processing component 110 controls the communication component 130 to provide the second linking request packet ARP2 to the second wireless access point 104, such that the second wireless access point 104 selectively builds the second wireless distribution system with the wireless access point 100 according to the second linking request packet ARP2.

The details of this method can be referred to the aforementioned paragraphs, so it will not be repeated here.

Through the operations of the above embodiment, the wireless access points in different states may be used to automatically build the wireless distribution system connection between them. In this way, it may be avoided to manually setting individual wireless distribution system settings, causing user inconvenience.

Reference will now be made in detail to the present embodiments of the disclosure, examples of which are illustrated in the accompanying drawings. It will be apparent to those skilled in the art that after understanding the embodiments of the present disclosure, various modifications and variations can be made based on the teaching of the disclosure without departing from the scope or spirit of the disclosure.

What is claimed is:

1. A wireless access point, comprising:
a communication component; and
a processing component,
wherein the processing component determines whether the wireless access point is in a first state or a second state;
under a condition that the wireless access point is in the first state, the wireless access point receives a first linking request packet from a first wireless access point via the communication component, and selectively controls the communication component to build a first wireless distribution system with the first wireless access point according to the first linking request packet; and
under a condition of the wireless access point is in the second state, the wireless access point controls the communication component to provide a second linking request packet to a second wireless access point, such that the second wireless access point selectively builds a second wireless distribution system with the wireless access point according to the second linking request packet.

2. The wireless access point of claim 1, further comprising:
a physical switching component, wherein the processing component is further determines whether the wireless access point is in the first state or the second state according to a corresponding switch state of the physical switching component.

3. The wireless access point of claim 1, wherein the communication component comprises a network interface,
wherein the network interface is a virtual wireless access point network interface or a wireless distribution system network interface.

4. The wireless access point of claim 1, wherein the processing component further verifies a verification information of the first linking request packet;
wherein under a condition that the verification passed, the processing component controls the communication component to build the first wireless distribution system connection with the first wireless access point; and
under a condition that the verification failed, the processing component prohibits the communication component from building the first wireless distribution system connection with the first wireless access point.

5. The wireless access point of claim 4, wherein the verification information is an organizationally unique identifier of the first wireless access point, a product name of the first wireless access point or a combination thereof.

6. An operating method of wireless access point, comprising:
determining the wireless access point is in a first state or a second state;
under a condition that the wireless access point is in the first state, receiving a first linking request packet from a first wireless access point, and selectively building a first wireless distribution system with the first wireless access point according to the first linking request packet; and
under a condition that the wireless access point is in the second state, providing a second linking request packet to a second wireless access point, so as to ask the second wireless access point to build a second wireless distribution system connection with the wireless access point according to the second linking request packet.

7. The operating method of claim 6, further comprising:
determining a network interface of the wireless access point;
wherein, the network interface is a virtual wireless access point network interface or a wireless distribution system network interface.

8. The operating method of claim 6, further comprising:
determining the wireless access point is in the first state or the second state according to a switching state of a physical switching component of the wireless access point, wherein the physical switching component changes the switching state in response to a user operation.

9. The operating method of claim 6, further comprising:
verifying a verification information in the first linking request packet;
under a condition that the verification passed, building the first wireless distribution system connection with the first wireless access point; and
under a condition that the verification failed, prohibiting an build of the first wireless distribution system connection with the first wireless access point.

10. The operating method of claim 9, wherein the verification information is an organizationally unique identifier of the first wireless access point, a product name of the first wireless access point, or a combination thereof.
